(19) United States
(12) Patent Application Publication
(10) Pub. No.: US 2012/0232920 A1
(43) Pub. Date: Sep. 13, 2012

(54) Method and System For Identifying The Appropriate Health Care Provider In Which to Assign Outcome Data From An Inpatient Case

(75) Inventors: Arthur Boll, Dayton, OH (US); Stephen Miller, Hamilton, OH (US)

(73) Assignee: Germane Solutions, Dayton, OH (US)

(21) Appl. No.: 13/414,182

(22) Filed: Mar. 7, 2012

Related U.S. Application Data
(60) Provisional application No. 61/449,945, filed on Mar. 7, 2011.

(51) Int. Cl. G06Q 50/22

(52) U.S. Cl. 705/2

(57) ABSTRACT

Included are embodiments for identifying the appropriate healthcare provider in which to assign outcome data from an inpatient case. Some embodiments include compiling inpatient cases for a healthcare facility, determining an attributable case by matching attribution indicator data for each of the inpatient cases with case data for each of the inpatient cases, and scoring physician activities based on the attribution indicator data. Some embodiments include attributing the inpatient cases to a physician, based on the scoring and providing the attribution to a user.

### CROSS REFERENCE

This application claims the benefit of U.S. Provisional Application No. 61/449,945, field Mar. 7, 2011, which is hereby incorporated by reference in its entirety.

### TECHNICAL FIELD

The present disclosure is directed to healthcare information systems, and in particular to a method and system for attributing responsibility for a patient's care to the most appropriate healthcare provider from all of the healthcare providers who interacted with the patient during the patient's hospitalization.

### BACKGROUND

In many medical establishments, tracking and benchmarking physician performance is important for determining physician quality and utilization measures, and/or for other reasons. Thus, many medical establishments, such as hospitals, determine “physician attribution” to identify a number of patients that a physician treats over a predetermined time period, as well how much time those physicians are spending with the patients. Typically, attribution is given to the admitting or discharging physician, but this may not be indicative of the physician who actually treated the patient.

The typical approach to assigning responsibility for a patient to a healthcare provider (e.g., a physician, etc.) is to assign responsibility for a patient to the healthcare provider that admitted or discharged the patient. For many patient stays, a number of physicians may be involved in the care of the patient during a hospital stay. In many cases, the physician who would be considered ‘most responsible’ for the care of the patient is likely not the admitting or discharging physician. Benchmarking physician performance is challenging using this approach because a patient stay may be attributed to an admitting or discharging physician that has only minimally contributed to the care of the patient.

### SUMMARY

Included are embodiments for identifying the appropriate healthcare provider in which to assign outcome data from an inpatient case. Some embodiments include compiling inpatient cases for a healthcare facility, determining an attributable case by matching attribution indicator data for each of the inpatient cases with case data for each of the inpatient cases, and scoring physician activities based on the attribution indicator data. Some embodiments include attributing the inpatient cases to a physician, based on the scoring and providing the attribution to a user.

Some embodiments of a system include a memory component that stores logic that causes the system to compile patient cases for a healthcare facility, determine an attributable case by matching attribution indicator data for each of the patient cases with case data for each of the patient cases, and identify a patient case that includes a complex medical treatment. In some embodiments, the logic causes the system to score physician activities based on the attribution indicator data, attribute the patient case to a physician, based on the scoring, and determine a confidence level of the attribution. In some embodiments, the logic causes the system to provide the attribution and the confidence level to a user.

Some embodiments of a non-transitory computer-readable medium include logic that, when executed by a computing device, causes the computing device to compile patient cases for a healthcare facility, determine an attributable case by matching attribution indicator data for each of the patient cases with case data for each of the patient cases, and identify a patient case that is associated with a complex medical condition. Similarly, in some embodiments, the logic causes the computing device to score physician activities based on the attribution indicator data, attribute the patient cases to a physician, based on the scoring, and provide the attribution to a user.

The following description and the annexed drawings set forth in detail certain illustrative aspects of the embodiments described herein. These aspects are indicative, however, of but a few of the various ways in which the principles of the embodiments shown and described herein may be implemented. Other advantages and novel features of the invention will become apparent from the following detailed description of the invention when considered in conjunction with the drawings.

### BRIEF DESCRIPTION OF THE FIGURES

FIG. 1 depicts a computing device that may be utilized for performing physician attribution, according to embodiments shown and described herein;

FIG. 2 depicts a flowchart for performing physician attribution, according to embodiments shown and described herein;

FIG. 3 depicts a flowchart for providing attribution and confidence of patient attribution to a user;

FIG. 4 depicts a user interface for providing a starting point for physician attribution, according to embodiments shown and described herein;

FIG. 5 depicts a user interface for providing attributed cases and a confidence level associated with the attributed cases, according to embodiments shown and described herein;

FIG. 6 depicts a user interface for providing relative value unit graphical data, according to embodiments shown and described herein;

FIG. 7 depicts a user interface for providing a number of cases that may be provided in a healthcare facility, according to embodiments shown and described herein;

FIG. 8 depicts a user interface for providing a number of consults that may be provided in a healthcare facility, according to embodiments shown and described herein;

FIG. 9 depicts a user interface for providing a diagnosis related group (DRG) report, according to embodiments shown and described herein;

FIG. 10 depicts a user interface for providing complications & comorbidity (CC) and/or major complications and comorbidity (MCC) reports, according to embodiments shown and described herein;

FIG. 11 depicts a user interface for providing an attribution report, according to embodiments shown and described herein;

FIG. 12 depicts a user interface for providing a reconciliation report, according to embodiments shown and described herein;

FIG. 13 depicts a user interface for providing an aging report, according to embodiments shown and described herein;

FIG. 14 depicts user interfaces for providing a length of stay report, according to embodiments shown and described herein;

FIG. 15 depicts user interfaces for providing a number of consults and a length of stay report, according to embodiments shown and described herein;

FIG. 16 depicts user interfaces for providing CC and MCC reports, according to embodiments shown and described herein; and

FIG. 17 depicts user interfaces for providing an attribution results report, according to embodiments shown and described herein.

### DETAILED DESCRIPTION

Accordingly, embodiments disclosed herein may be configured to provide an internet or intranet interface for determining and tracking physician attribution. As an example, embodiments may include determining which patient cases are attributable to a physician. Identifying an attributable case may be performed by matching attribution indicator data with case data provided by the hospital. The attribution indicator data may include billing data, charge capture data, computerized physician order entry data, operating room logs, and/or other data. Additionally, the embodiments may include excluding outlier cases from the set of attributable cases, such as for patients that stay at the hospital beyond a threshold time, patients with extremely complex conditions, etc.

The embodiments may also include scoring physician activities for each physician using Medicare work relative value units (WRVUs). Once scoring is complete, cases and/or patients may be attributed to particular physicians. Physician attribution may be applied on at least one desired level, including: the department with the highest score, the division with the highest score, and the individual physician with the highest score. Additionally, tie breakers may be implemented, such as: the physician that saw the patient last, the physician that was listed last, the discharge physician, and/or the physician whose specialty matches an expected diagnosis related group (DRG).

The embodiments may also include determining confidence levels for each case. The confidence score may be calculated using a formula, such as an average of a department confidence score, a division confidence score, and a case confidence score. Additionally, a different level of review may be applied, based on the determined confidence level.

It is to be appreciated that the embodiments of the present disclosure relate to a computer-based system and method for attributing a patient stay to a physician. It should be understood that embodiments disclosed herein are not limited to a particular technology, computer platform, particular processor, particular high-level programming language or Web service. Additionally, the computer system may be a multiprocessor computer system or may include multiple computers connected over a computer network.

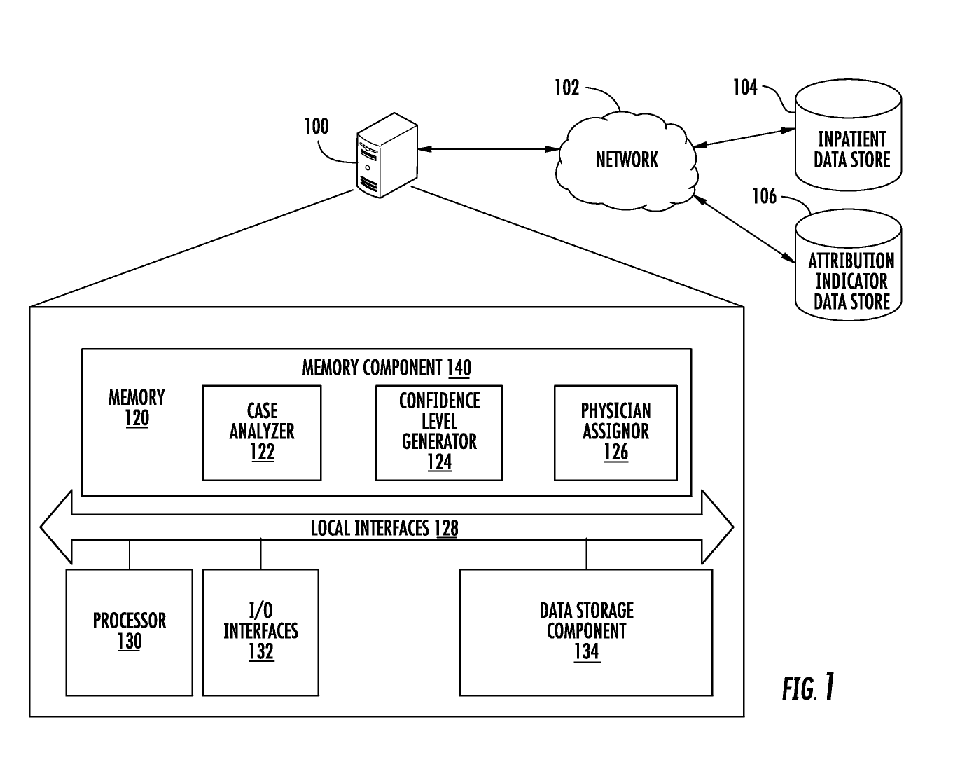

FIG. 1 depicts a computing device 100 that may be utilized for performing physician attribution, according to embodiments shown and described herein. The computing device 100 communicates over a computer network 102 with an inpatient data store 104 and an attribution indicator data store 106. The attribution indicator data store 106 may include professional billing data, computerized physician order entry data, and/or charge capture data, and/or other types of data. The network 102 may be any combination of wired (e.g., fiber optic, Ethernet, DSL, etc.) and/or wireless connections (e.g., WiFi, cellular, etc.). The inpatient data store 104 and attribution indicator data store 106 may be separate computing devices that store inpatient case data and attribution indicator data information.

The computing device 100 is shown to include a processor 130 that communicates with I/O interfaces 132, a data store 134, and a memory component 120 via a local interface 128. The I/O interfaces 132 may include any number of internal and external interfaces to convey information to other electronic devices (e.g., a display interface, a network interface, a speaker interface, etc.). The data store 134 may include any combination of physical storage such as one or more hard drives, a DVD, a CD-ROM, or other forms of a non-transitory computer-readable medium.

The memory component 120 is shown to include at least one piece of logic, such as case analyzer 122, a confidence level generator 124, and a physician assignor 126, which may be implemented as software, hardware, firmware, and/or the like. The case analyzer 122 may cause the computing device 100 to receive Inpatient case data from the inpatient data store 104 and attribution indicator information from the attribution indicator data store 106 and uses the retrieved data to determine which cases associated with the Inpatient case data and attribution indicator information cannot be attributable to a physician. For example, the case analyzer 122 may determine that cases having duplicate billing numbers or missing information may be excluded. The case analyzer 122 may also identify and exclude outlier cases using the DRG and inpatient attribution indicator data. For example, cases having patient stays longer than a given threshold value or cases involving multiple physicians may be excluded by the case analyzer 122.

A physician assignor 126 causes the computing device 100 to analyze the cases based on the DRG type assigned to each case and scores physician activities associated with each physician that provided care in the case. The physician assignor 126 may also cause the computing device 100 to use these scores to attribute the case to a particular physician.

Similarly, the confidence level generator 124 may cause the computing device 100 to generate one or more confidence scores associated with a case attributed to a physician. In some embodiments, the confidence level generator 124 may cause the computing device 100 calculate the confidence level as being the average of the following: Total points of Department/Total points assigned for the medical case=Department Confidence Score (%); Total points of Division/Total points assigned for the medical case=Division Confidence Score (%); and Total points of physician/Total points assigned for the medical case=Case Confidence Score (%).

Similarly, the case analyzer 122 may cause the computing device 100 to determine one or more levels of review for the cases and provide the attributed cases, confidence levels, and/or outlier cases to other electronic devices (e.g., an electronic display, another computer system in the network 102, a speaker, etc.) via the I/O interfaces 132.

While specific components of the computing device 100 are depicted in FIG. 1, it should be appreciated that these are illustrative embodiments only. For example, the components of the memory component 120 may be located on disparate computing devices (e.g., via cloud computing) and/or the memory component 120 may include one or more memory devices. Similarly, while the inpatient data store 104 and the attribution indicator data store 106 are shown as remote storage locations from computing device 100, this is also merely an example. In some embodiments, data residing in the inpatient data store 104 and/or the attribution indicator data store 106 may be stored in data store 134 and/or located within memory component 120.

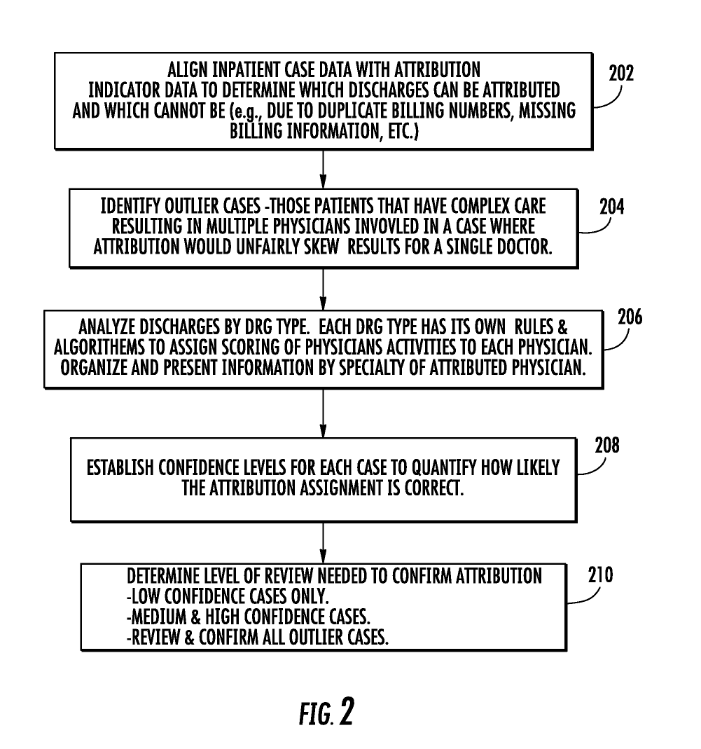

FIG. 2 depicts a flowchart for performing physician attribution, according to embodiments shown and described herein. The flowchart includes determining which patient cases may be attributable to a physician (block 202). In some embodiments, the attributable cases may be determined by matching physician Part B attribution indicator data (individual billings submitted by each physician relating to their involvement in a specific medical case) with DRG case data (diagnoses of the patient and length of stay information) provided by the hospital. By merging these two disparate pieces of information, a better picture of the care that was provided for each patient may while they were at the hospital may be determined. Similarly, a determination of the physician that provided that care to the patient may be made. Discharges that have duplicate or missing information may be excluded from the set of discharges to be attributed to the physicians.

The flowchart also includes identifying outlier cases from the set of attributable cases (block 204). Generally, an outlier case may be any case that has atypical attributes or may skew the time attributable to a particular physician. For example, cases where patient stays above beyond a predetermined amount of time (e.g., greater than 10 days, greater than 20 days, etc.) or complex cases involving a number of physicians above a given threshold (e.g., four physicians, five physicians, etc.) may be identified by the computer and excluded from the set of attributable cases. In some embodiments, the computing device 100 may receive one or more parameters from a user interface device that defines the thresholds. For example, an administrator may utilize the interface device to change the patient stay threshold from 10 days to 20 days. In some embodiments, one or more of the following types of outliers may be identified: (1) Complex care outliers—Many cases are very complex with multiple physicians providing a variety of services throughout the inpatient stay. In those cases, it is difficult to assign the case to a single physician because of the complexity of the case and the number of physicians involved; and (2) length of stay (LOS) Outliers.

Complex care outliers may be identified, in some embodiments, using Medicare Work Relative Value Units (WRVUs). For example, if the combined WRVUs for the case are greater than a Complex Care Threshold, the case may be identified as an outlier. The Complex care threshold may be a function of the DRG weight and a Complex care multiplier (e.g., a multiple of, etc.). For example, the threshold may be calculated using the following: (i) Complex Care Threshold=DRG Weight for the Assigned DRG*Complex Care Multiplier. In some embodiments, the Complex Care Multiplier may be a function of the DRG type. For example, the following complex care multipliers may be used: (i) Surgical DRG multiplier−10.0; (ii) medical DRG multiplier−5.0; and/or (iii) Other/exempt DRG multiplier−5.0.

In some embodiments, length of stay outliers may be determined using the length of stay for a particular DRG (e.g., a simple geometric mean value, etc.). For example, an outlier may be identified as having an actual length of stay that is greater than two times the Medicare geometric mean average length of stay for its associated DRG or some other criteria established by each hospital for physician attribution purposes. In other examples, any multiple of the length of stay may be used to determine outliers.

The flowchart further includes scoring physician activities to each physician (block 206). After the inpatient attribution indicator data and inpatient case data has been merged, each case may be individually “scored” using Medicare work relative value units (WRVUs). Scoring may be performed to calculate the amount of professional input that should be provided by each physician involved in the case, as well as determine each physician's relative involvement as a percentage of all physicians included in the case scoring. In general, WRVUs generated by all physicians involved in the case are included in the scoring. However, in some embodiments, WRVUs may be intentionally eliminated or ignored in limited instances in order to provide better clarity in assigning attribution. For example, some physicians may not be eligible for assignment as the responsible physician based on certain rules and restrictions. As a result, any scoring is eliminated for these physicians or services in order to improve clarity in assigning the most appropriate physician. This information may then be used to determine the physician who has the most professional input into the case.

Once each inpatient case has been matched to the attribution indicator data and scoring is completed, cases may be attributed to particular physicians. In some embodiments, this may be determined based on the overall level and distribution of physician activity (preponderance of care) during the inpatient stay for each patient. Physician attribution may be applied on three levels: The department with the most points (e.g., internal medicine)—highest Level; The division with the most points (e.g., endocrinology)—second highest level; and/or the Physician with the most points (e.g., Dr. Smith)—third highest level.

In some cases, tie breaking may also be employed. Given the vast number of cases annually at each hospital, simple numeric scoring will not always be sufficent in determining preponderance of care. In the event that two or more physicians have the same score, one or more of the following “tie breaker” provisions may be applied to determine attribution: (1) The physician that saw the patient last; (2) The physician that was listed as the discharge physician; or (3) The physician whose specialty matches the expected DRG (or other inpatient case data) for the case.

According to some embodiments, exceptions may also be applied to the attribution process to exclude specified categories of healthcare providers. For example, exceptions may exist for one or more of the following: (1) Physicians acting as consultants; (2) emergency medicine and pathology; and/or (3) podiatrists.

In some embodiments, one or more of the exceptions may not be eligible to receive any points during the scoring process. In some embodiments, one or more of the exceptions may be included in the scoring process, but attribution passes to the physician having the highest point total and in an eligible category for attribution.

The flowchart of FIG. 2 further includes establishing confidence levels for each assigned case (block 208). In addition to the attribution, a score is also created that displays the level of confidence we have in assigning preponderance of care to that physician. The confidence score is created using the following formula: Average of the following confidence score calculations where.

$$\frac{Total points of Department}{Total points assigned for the medical case} = Department Confidence Score ( \% ) ;$$

$$\frac{Total points of Divison}{Total points assigned for the medical case} = Division Confidence Score ( \% ) ; and$$

$$\frac{Total points of physician}{Total points assigned for the medical case} = Case Confidence Score ( \% ) .$$

The process further includes determining a level of review for the assigned cases (block 210). For example, different levels of review may be required for cases having confidence values below a given threshold or within a specified range, or for cases that were identified as being outliers. In addition, the cases may be placed into three distinctive categories based on the treatment diagnosis related gropus:

Medical—Encompasses cases typically related to medical care of an adult. Medical is the largest category and includes (but is not limited to) cases involving endocrinology, gastroenterology, hematology, general medicine, infectious diseases, oncology, nephrology, pulmonary, and rheumatology.

Surgery—Encompasses cases where the initial treatment typically involves some type of surgical care. This may include (but not limited to) general, plastic, neurological, bariatric, cardiac, and colorectal surgeries.

Other/Exempt—Encompasses all cases not otherwise categorized. Typically, this is comprised mostly of patients whose primary treatment involves psychiatry and/or physical medicine and rehabilitation.

In some embodiments, the flowchart of FIG. 2 may additionally include presenting the confidence values to an electronic display (not shown). For example, cases having low confidence values may be presented to a display for review by a billing administrator or other authorized user. In another embodiment, cases determined to be outliers may also be presented to the display. In this way, an authorized user may review those cases that were difficult to automatically assign to a physician.

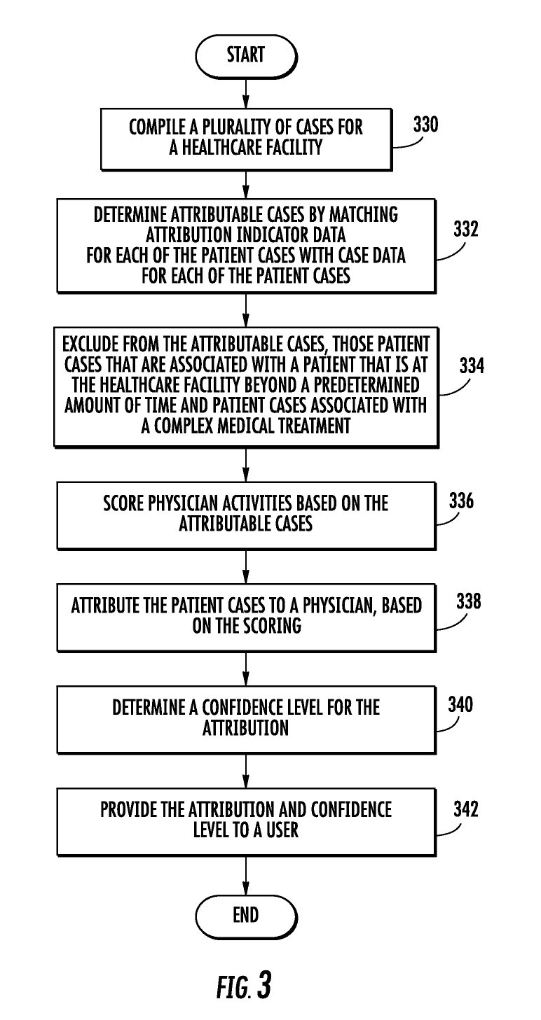

FIG. 3 depicts a flowchart for providing attribution and confidence of patient attribution to a user. As illustrated in block 330, a plurality of patient cases may be compiled for a healthcare facility. In block 332, attributable cases may be determined by matching attribution indicator data for each of the patient cases with case data for each of the patient cases. In block 334, those patient cases that are associated with a patient that stayed at the healthcare facility beyond a predetermined amount of time and patient cases associated with a complex medical treatment may be excluding from the attributable cases. In block 336, physician activities may be scored based on the attributable cases. In block 338, the patient cases may be attributed to a physician, based on the scoring. In block 340, a confidence level of the attribution may be determined. In block 342, the attribution and confidence level may be provided to a user.

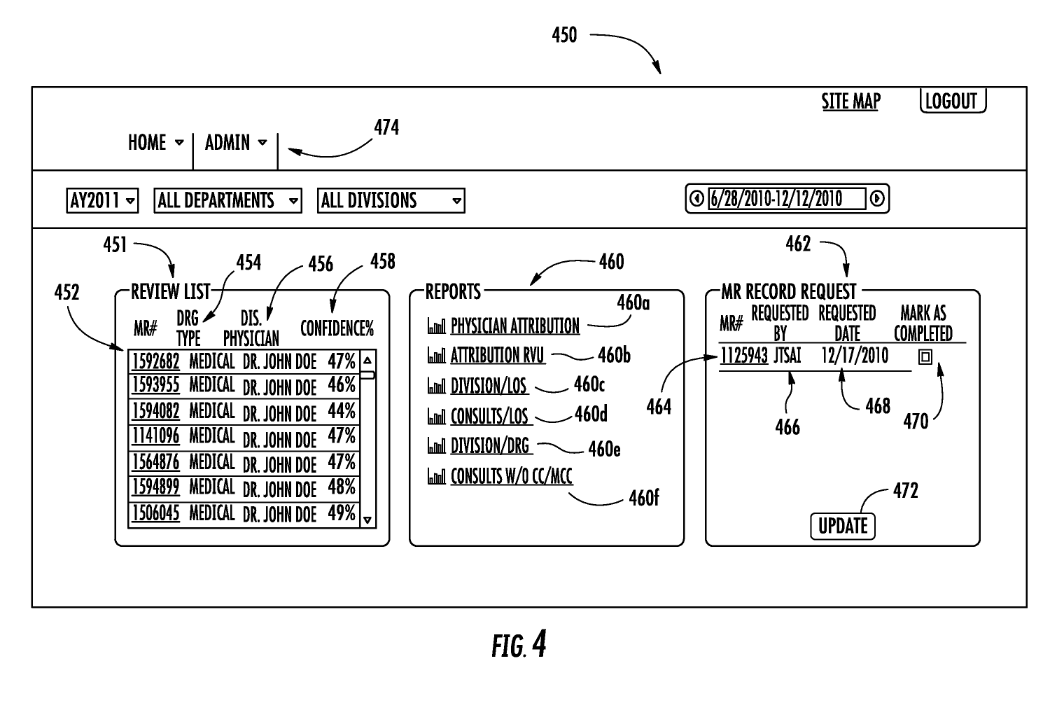

FIGS. 4-17 depict a plurality of interfaces for providing physician attribution, according to embodiments shown and described herein. The user interfaces may be provided, for example, by computing device 100 to an electronic device via the I/O interfaces 132 (FIG. 1). The interfaces include a number of reporting features that convey information about the physician attribution system to a user.

FIG. 4 depicts a user interface 450 for providing a starting point for physician attribution, according to embodiments shown and described herein. As illustrated, the user interface 450 includes a plurality of fields for providing attribution data, as described herein. Specifically, the user interface 450 includes a review list 451, which includes a medical record number column 452, a DRG type column 454, a discharging physician column 456, and a confidence percentage column 458. The DRG type column 454 may provide the type of interaction the patient had for this record number. The discharging physician column 456 may identify the physician that discharged the patient. The confidence percentage identifies the confidence that the determined attribution is correct.

Also included is a reports column 460. The reports column 460 may include a physician attribution option 460a, an attribution RVU option 460b, a division/LOS option 460c, a consults/LOS option 460d, a division/DRG option 460e, and a consults w/o CC/MCC option 460f. In response to selection of an option from the reports column 460, another user interface may be provided, as described in more detail below.

Also included is a medical record request section 462. The medical record request section 462 may include a medical record column 464, a requested by option 466, a request date column 468, a mark as completed column 470, and an update option 472. Specifically, when a record request is complete, the user may select the corresponding checkbox in the mark as completed column 470 and select the update option 472 to save the change. An admin option 474 may also be included for providing administrative options, as described in more detail, below.

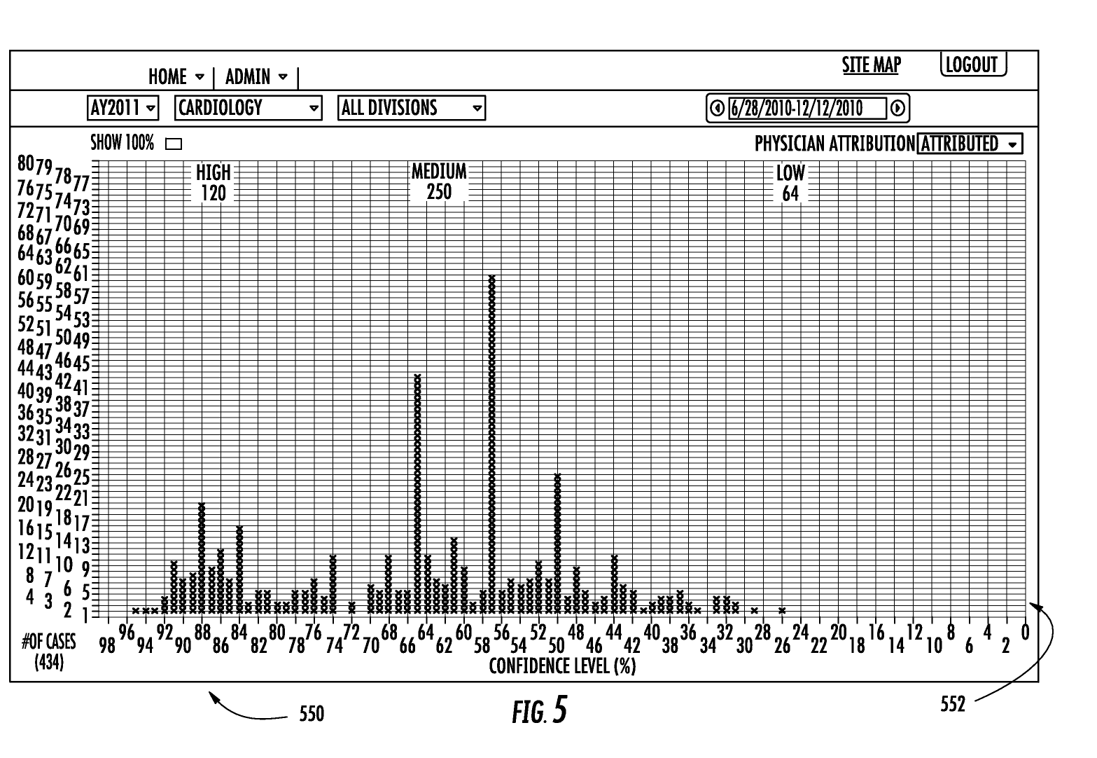

FIG. 5 depicts a user interface 550 for providing attributed cases and a confidence level associated with the attributed cases, according to embodiments shown and described herein. In response to selection of the physician attribution option 460a, from FIG. 4, the user interface 550 and an attribution graph 552 may be provided. Specifically, the attribution graph 552 may provide information relating the number of patient cases that have been assigned to their respective attribution confidence levels (from from the confidence percentage column 458 if FIG. 4). For example, a user is able to see a breakdown of which cases have a low associated confidence level. The user interface 550 also includes administrative functions that allow a user to update the cases.

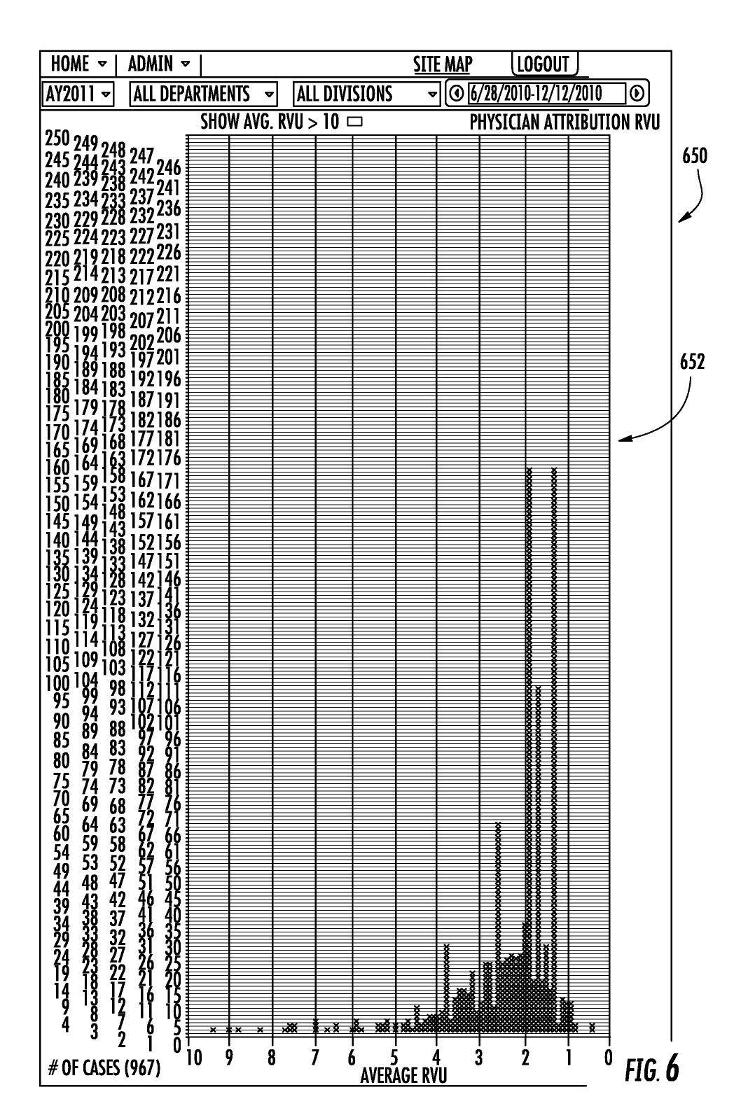

FIG. 6 depicts a user interface 650 for providing relative value unit graphical data, according to embodiments shown and described herein. In response to selection of the attribution RVU option 460b, from FIG. 4, the user interface 650 may be provided. Specifically, the user interface 650 may include a relative value unit (RVU) report graph 652 that provides the number of cases by the RVU average. As an example, an RVU value is computed for each of the cases at a medical facility. The graph 652 may provide the number of cases at each of a plurality of different RVU averages.

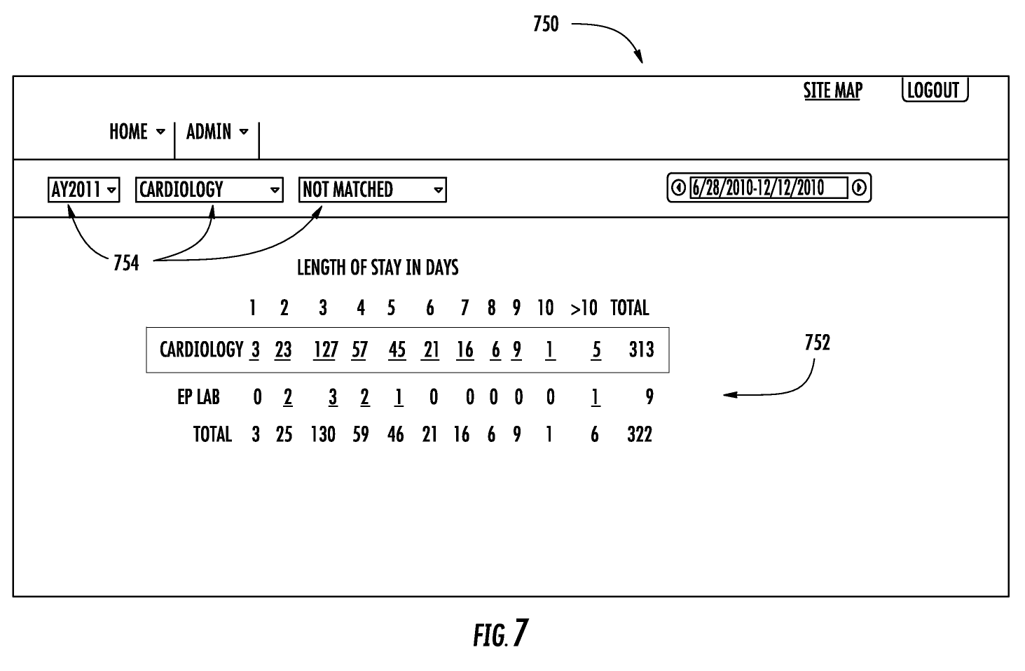

FIG. 7 depicts a user interface 750 for providing a number of cases that may be provided in a healthcare facility, according to embodiments shown and described herein. In response to selection of the division/LOS option 460c from FIG. 7, the user interface 750 may be provided. Specifically, the user interface 750 may report the number of cases in the selected division by the length of stay at the medical facility. Additionally, in response to selection of the options 754, other divisions may be provided to the user.

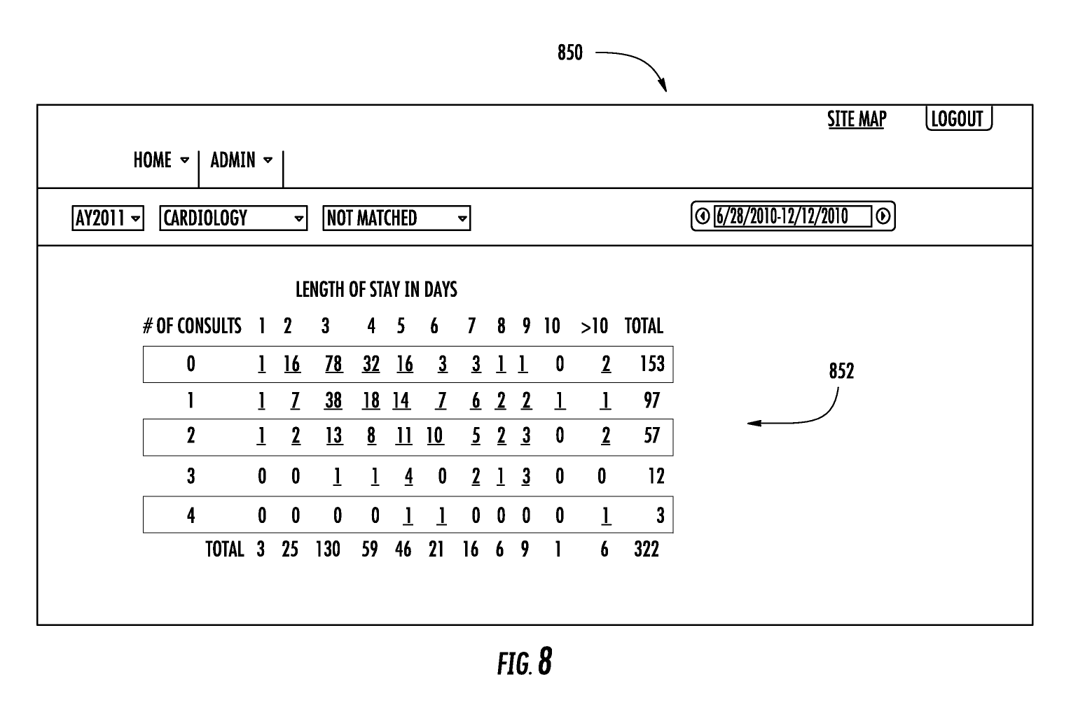

FIG. 8 depicts a user interface 850 for providing a number of consults that may be provided in a healthcare facility, according to embodiments shown and described herein. In response to selection of the consults/LOS option 460d from FIG. 4, the user interface 850 may be provided. Specifically, the user interface 850 includes a calendar section 852 that provides the consults length of stay report. This report displays the number of consults by length of stay.

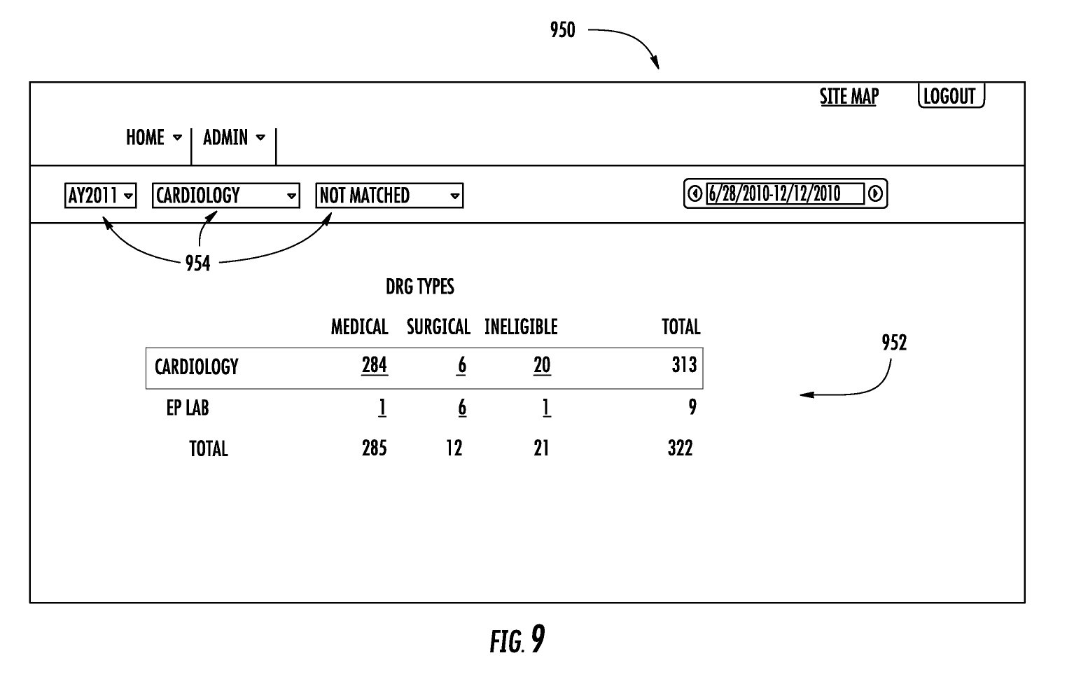

FIG. 9 depicts a user interface 950 for providing a diagnosis related group (DRG) report 952, according to embodiments shown and described herein. In response to selection of the division/DRG option 460e from FIG. 4, the user interface 950 and division DRG report 952 may be provided. The division DRG report 952 may provide the number of cases in the selected division by DRG type. A user may access other divisions by utilizing one or more of the options 954.

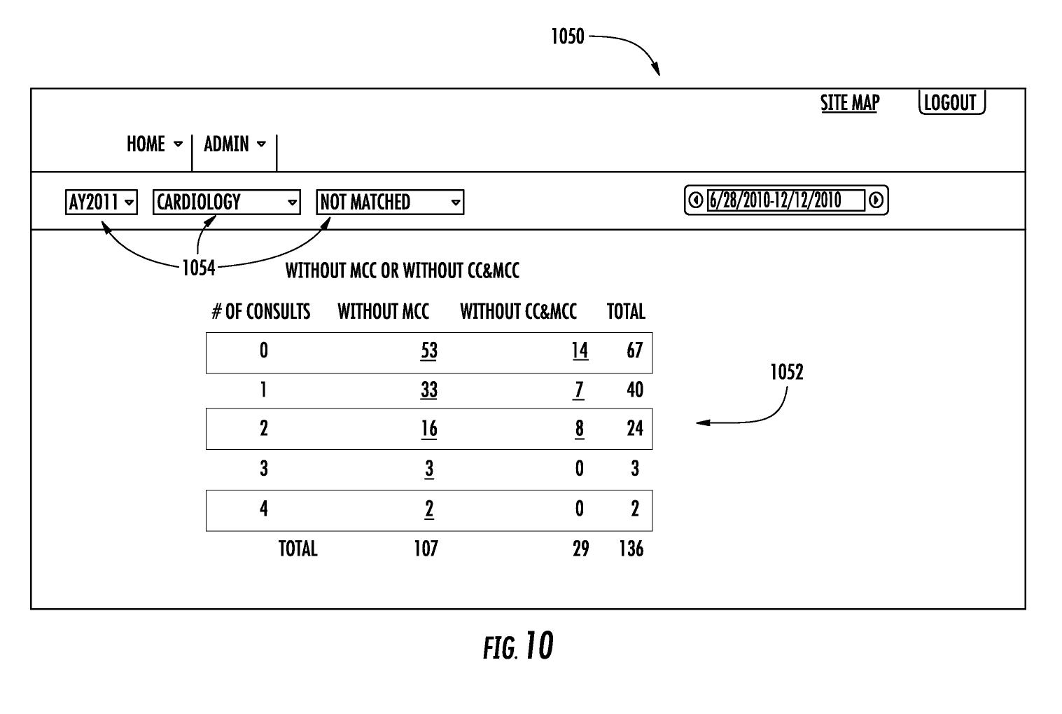

FIG. 10 depicts a user interface 1050 for providing complications and comorbidity (CC) and/or major complications and comorbidity (MCC) reports 1052, according to embodiments shown and described herein. In response to selection of the consults w/o CC/MCC option 460f from FIG. 4, the user interface 1050 may be provided. The user interface 1050 may include the CC and/or MCC report 1052, which provides the number of consults without MCC and without CC & MCC. A user option 1054 may be provided for viewing a different division.

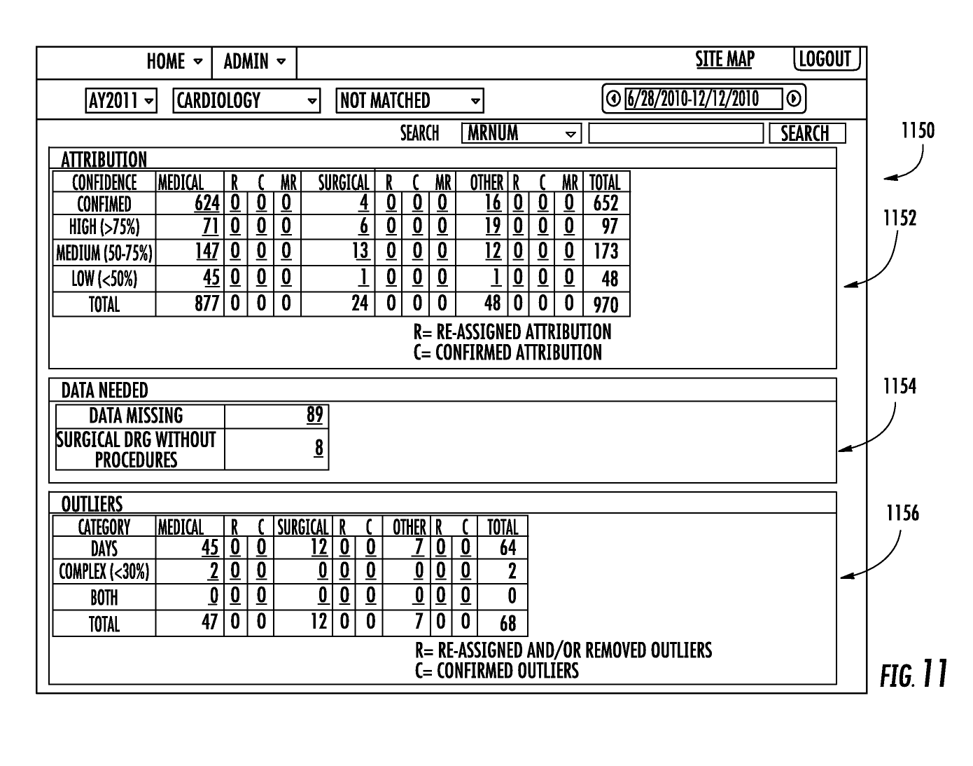

FIG. 11 depicts a user interface 1150 for providing an attribution report, according to embodiments shown and described herein. In response to selection of the admin option 474 from FIG. 4, the user interface 1150 may be provided. Specifically, the user interface 1150 includes an attribution report 1152, a data needed report 1154, and an outliers report 1156. The attribution report 1152 may include confidence levels and DRG types for a plurality of cases. As an example, in the example of FIG. 11, there are 624 confirmed medical cases. This means that 624 of the medical cases have an attribution assignment with 100% confidence. The attribution report 1152 additionally has 4 confirmed surgical, and 16 confirmed other.

Additionally, the data needed report 1154 includes the number of cases where data is missing and the number of cases where the surgical DRG is without procedures. The outliers report 1156 includes those cases that have been identified and/or excluded from attribution due to factors such as exceeding a predetermined amount of time at the medical facility, for a complex medical treatment, and/or for a complex medical condition.

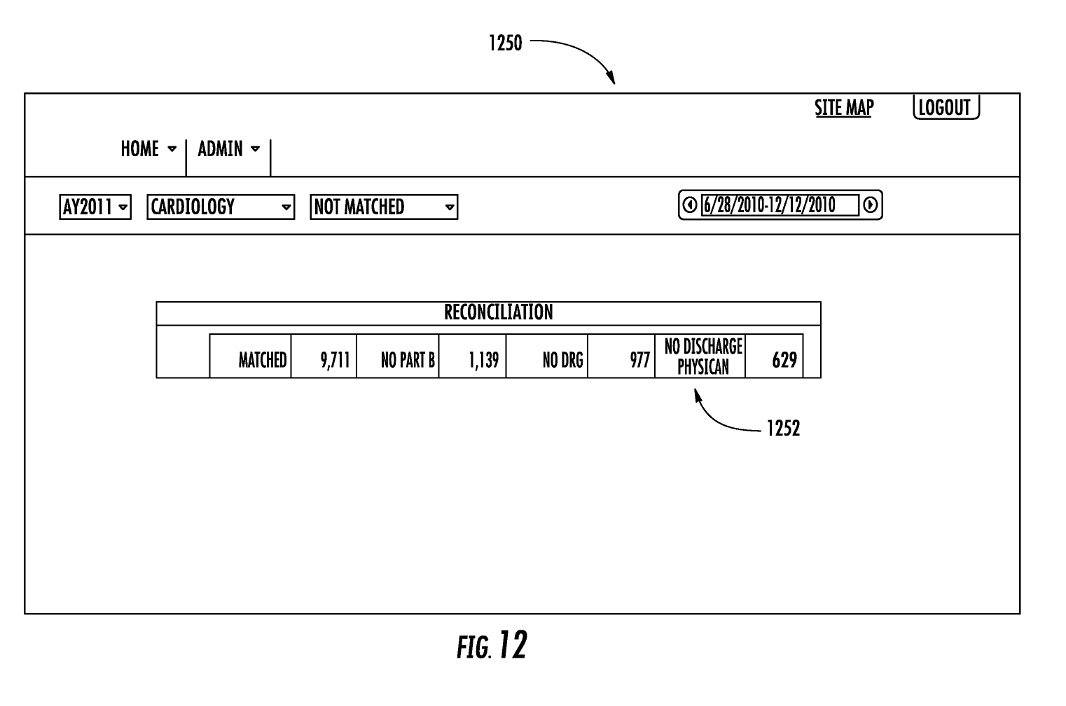

FIG. 12 depicts a user interface 1250 for providing a reconciliation report 1252, according to embodiments shown and described herein. In response to selection of the admin option 474 from FIG. 4, the user interface 1250 and reconciliation report 1252 may be provided. The reconciliation report 1252 may provide a number of cases that have been matched, with no part B, no DRG, and no physician discharge.

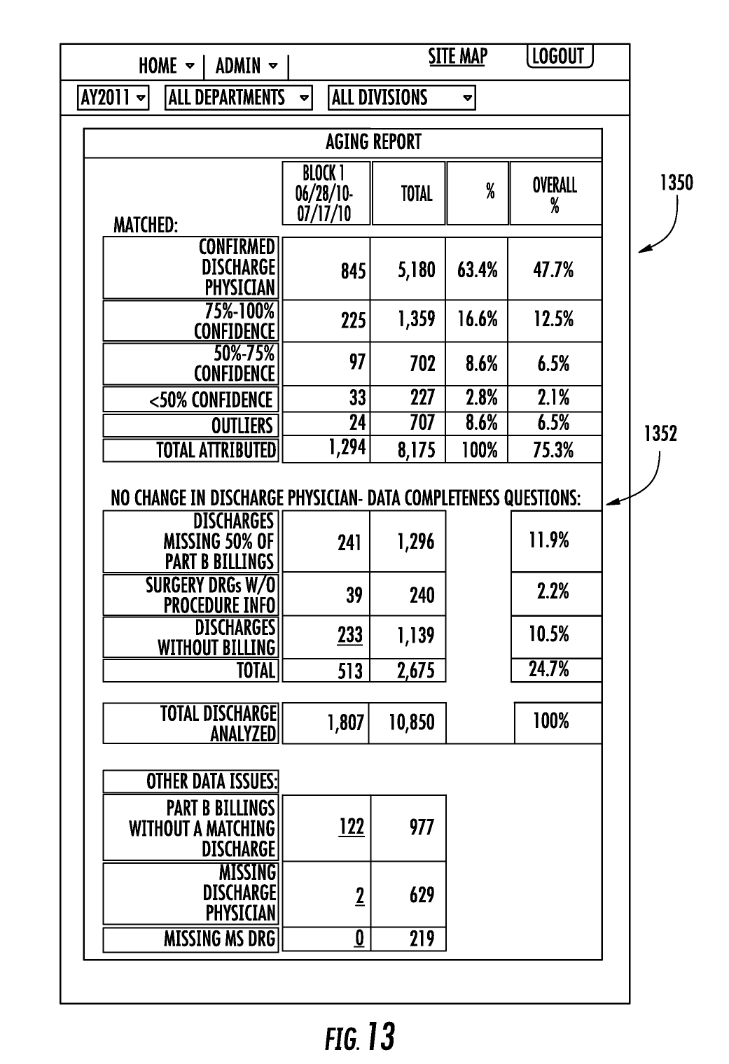

FIG. 13 depicts a user interface 1350 for providing an aging report 1352, according to embodiments shown and described herein. In response to selection of the admin option 474 from FIG. 4, the user interface 1350 and aging report 1352 may be provided. The aging report 1352 may provide a number of attributed cases in each block of academic years that are matched. Additionally a confidence level is provided. The aging report 1352 additionally provides a number of attributed cases in which there was no change in discharge physician and splits those cases into data completeness question categories. The aging report 1352 may also provide a number of attributed cases that fall into any other data issue category.

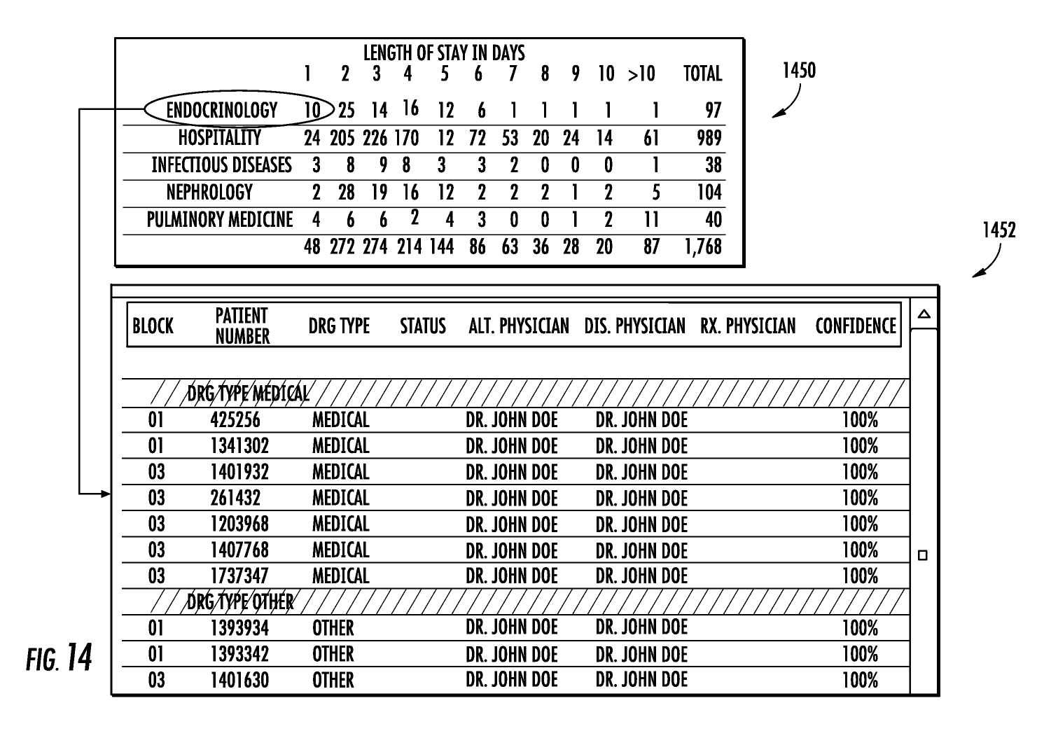

FIG. 14 depicts user interfaces for providing a length of stay report, according to embodiments shown and described herein. As illustrated, similar to the user interface 750 from FIG. 7, the user interface of FIG. 14 includes a length of stay report 1450 the compiles every medical case by division and by length of stay, giving a visual representation of the data that comprises the division's current LOS. Further, a details report 1452 is included and provides the patient number, DRG type, the status, the attending physician, the discharging physician, the responsible physician, and the confidence percentage.

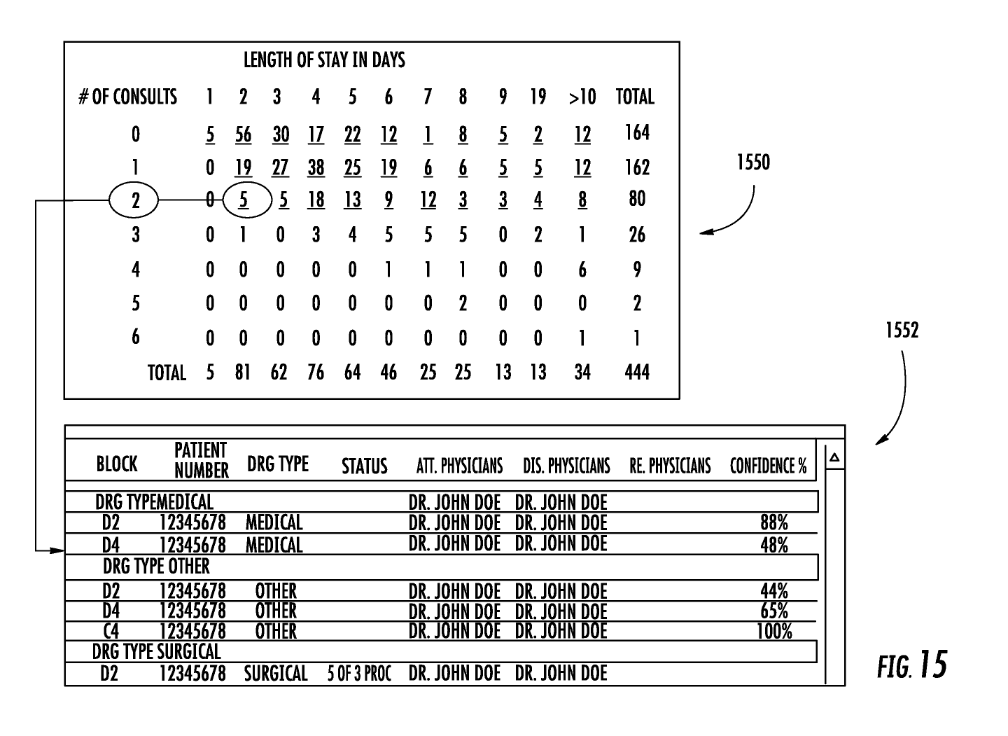

FIG. 15 depicts user interfaces for providing a number of consults and a length of stay report, according to embodiments shown and described herein. Similar to the user interface 850 from FIG. 8, the user interface of FIG. 15 includes a length of stay report 1550 and a details report 1552. The length of stay report 1550 provides a number of consults in conjunction with each case. The length of stay report 1550 may provide a correlation between the number of consults provided and the length of stay. Generally speaking, the longer the stay, the greater the number of consults.

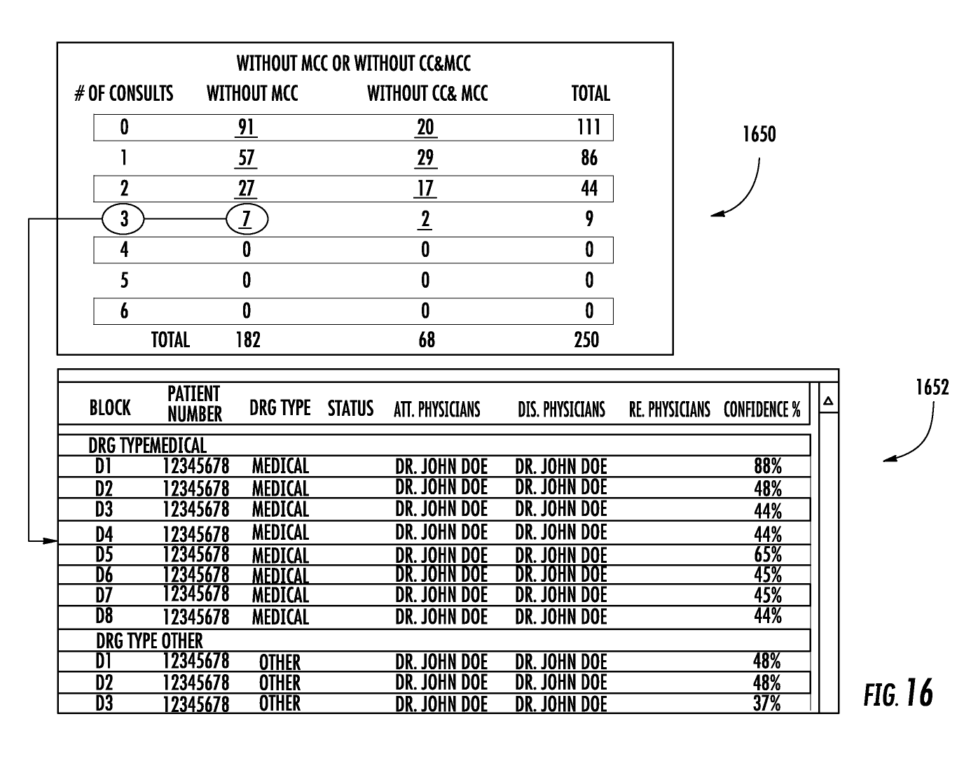

FIG. 16 depicts user interface for providing CC and MCC reports, according to embodiments shown and described herein. Similar to the user interface 950 from FIG. 9, the user interfaces of FIG. 16 include a CC/MCC report 1650 and a details report 1652. The CC/MCC report provides a number of consults on medical cases whose DRG includes a “with or without CC/MCC” designation. This identifies potential coding errors related to the face that a “without CC/MCC” case may be less complicated, and thus require fewer consults.

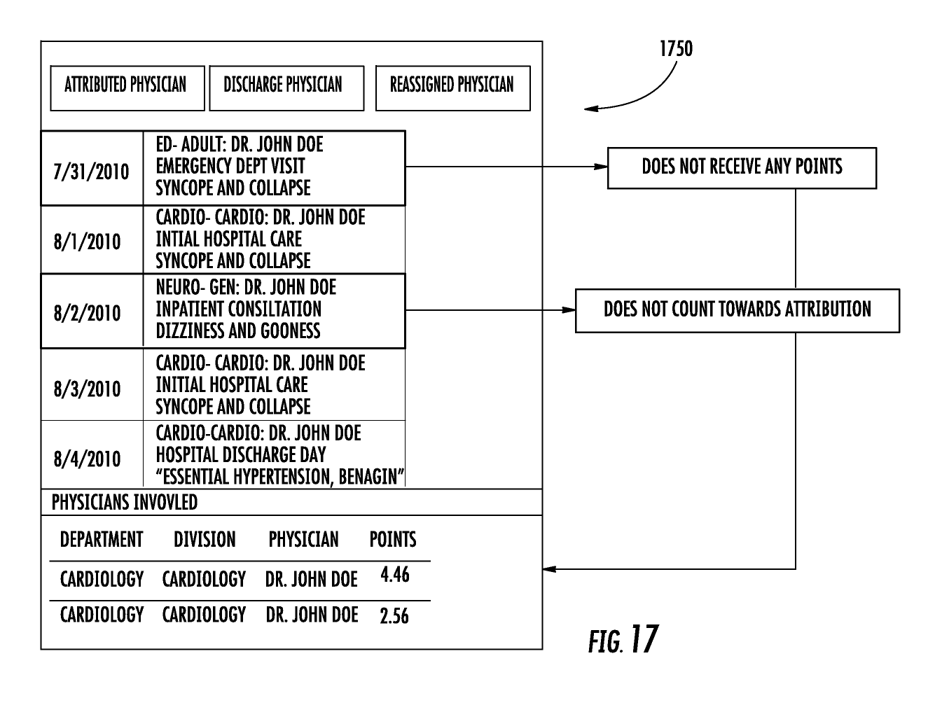

FIG. 17 depicts a user interface 1750 for providing an attribution results report, according to embodiments shown and described herein. As illustrated, the user interface 1750 may include attributed physicians, discharging physicians, and reassigned physicians. Additionally, as indicated in the user interface 1750, the physicians may be identified as not receiving any points for treating a patient. This may be because the patient has an overly complex symptom and/or overly complex treatment; because the patient has stayed at the healthcare facility; and/or for other reasons. Accordingly, the physician may not receive any attribution points for these cases.

Many modifications and variations of embodiments of the present disclosure are possible in light of the above description. The above-described embodiments of the various systems and methods may be used alone or in any combination thereof without departing from the scope of the invention. Although the description and figures may show a specific ordering of steps, it is to be understood that different orderings of the steps are also contemplated in the present disclosure. Likewise, one or more steps may be performed concurrently or partially concurrently.

The various operations of the methods and systems in the present disclosure may be accomplished using one or more processing circuits. For example a processing circuit may be an ASIC, a specific-use processor, or any existing computer processor. One or more steps or functions in the present disclosure may also be accomplished using non-transitory, machine-readable instructions and data structures stored on machine-readable media. For example, such media may comprise a floppy disc, CD-ROM, DVD-ROM, RAM, EEPROM, flash memory, or any other medium capable of storing the machine-executable instructions and data structures and capable of being accessed by a computer or other electronic device having a processing circuit.

Therefore, at least the following is claimed:

1. A method for identifying the appropriate healthcare provider in which to assign outcome data from an inpatient case, comprising:
compiling inpatient cases for a healthcare facility;
determining an attributable case by matching attribution indicator data for each of the inpatient cases with case data for each of the inpatient cases;
scoring physician activities based on the attribution indicator data;
attributing the inpatient cases to a physician, based on the scoring; and
providing the attribution to a user.

2. The method of claim 1, further comprising excluding from scoring, the patient case that is associated with the patient that stayed at the healthcare facility beyond the predetermined amount of time.

3. The method of claim 1, wherein the confidence level is determined based on an average of a department confidence score, a division confidence score, and a case confidence score.

4. The method of claim 1, further comprising identifying a patient case that is associated with a patient with a complex medical condition.

5. The method of claim 1, wherein the physician activities are scored based on a diagnosis related group (DRG) type.

6. The method of claim 1, further comprising determining a desired level of for the attribution.

7. The method of claim 1, further comprising providing a length of stay report, the length of stay report providing a number of inpatient cases associated with the healthcare facility, divided by division and length of stay.

8. A system for identifying the appropriate healthcare provider in which to assign outcome data from an inpatient case, comprising:
a memory component that stores logic that causes the system to perform at least the following:
compile patient cases for a healthcare facility;
determine an attributable case by matching attribution indicator data for each of the patient cases with case data for each of the patient cases;
identify a patient case that includes a complex medical treatment;
score physician activities based on the attribution indicator data;
attribute the patient cases to a physician, based on the scoring;
determine a confidence level of the attribution; and
provide the attribution and the confidence level to a user.

9. The system of claim 8, wherein the logic further causes the system to exclude from scoring, the patient case that includes the complex medical treatment.

10. The system of claim 8, wherein the confidence level is determined based on an average of a department confidence score, a division confidence score, and a case confidence score.

11. The system of claim 8, wherein the logic further causes the system to identify a patient case that is associated with a patient with at least one of the following: a complex medical condition and a patient that stayed at the healthcare facility beyond a predetermined amount of time.

12. The system of claim 8, wherein the physician activities are scored based on a diagnosis related group (DRG) type.

13. The system of claim 8, wherein the logic further causes the system to determine a desired level of for the attribution.

14. The system of claim 8, wherein the logic further causes the system to provide a length of stay report, the length of stay report providing a number of patient cases associated with the healthcare facility, divided by division and length of stay.

15. A non-transitory computer-readable medium for identifying the appropriate healthcare provider in which to assign outcome data from an inpatient case that stores logic that, when executed by a computing device, causes the computing device to perform at least the following:
compile patient cases for a healthcare facility;
determine an attributable case by matching attribution indicator data for each of the patient cases with case data for each of the patient cases;
identify a patient case that is associated with a complex medical condition;
score physician activities based on the attribution indicator data;
attribute the patient cases to a physician, based on the scoring; and
provide the attribution to a user.

16. The non-transitory computer-readable medium of claim 15, wherein the logic further causes the computing device to exclude from scoring, the patient case that is associated with the complex medical condition.

17. The non-transitory computer-readable medium of claim 15, wherein the confidence level is determined based on an average of a department confidence score, a division confidence score, and a case confidence score.

18. The non-transitory computer-readable medium of claim 15, wherein the logic further causes the computing device to determine a confidence level of the attribution.

19. The non-transitory computer-readable medium of claim 15, wherein the physician activities are scored based on a diagnosis related group (DRG) type.

20. The non-transitory computer-readable medium of claim 15, wherein the logic further causes the computing device to determine a desired level of for the attribution.
